(19) United States
(12) Patent Application Publication
(10) Pub. No.: US 2019/0248421 A1
(43) Pub. Date: Aug. 15, 2019

(54) ROOF ASSEMBLY FOR AN AUTONOMOUS WORK VEHICLE

(71) Applicant: CNH Industrial America LLC, New Holland, PA (US)

(72) Inventors: Eric Michael Jacobsthal, Elmhurst, IL (US); Russell Alan Meyer, Crystal Lake, IL (US); Kevin Michael Smith, Narvon, PA (US)

(73) Assignee: CNH Industrial America LLC

(21) Appl. No.: 16/269,198

(22) Filed: Feb. 6, 2019

Related U.S. Application Data
(60) Provisional application No. 62/628,329, filed on Feb. 9, 2018.

(51) Int. Cl. B62D 25/06; B60Q 1/26; B60H 1/00; B60H 1/24

(52) U.S. Cl. CPC B62D 25/06; B60Q 1/2611; B60H 1/00378; B60Y 2410/10; B60H 2001/00235; B60Y 2200/221; B60H 1/245

(57) ABSTRACT

A roof assembly for an autonomous work vehicle includes a roof panel having an outer surface. The roof assembly also includes a lighting assembly having a light-transmissive panel and a light source. The light-transmissive panel is coupled to the roof panel, the light-transmissive panel has an outer surface, the outer surface of the roof panel completely surrounds the outer surface of the light-transmissive panel, and the light source is configured to emit light through the light-transmissive panel. The light source is configured to receive a signal from a controller indicative of a selected status indication of a group of status indications and to emit the light based on the selected status indication, the group of status indications correspond to a respective group of operating states of the autonomous work vehicle, and the selected status indication corresponds to a current operating state of the group of operating states.

### CROSS REFERENCE TO RELATED APPLICATION

This application claims priority from and the benefit of U.S. Provisional Application Ser. No. 62/628,329, entitled “ROOF ASSEMBLY FOR AN AUTONOMOUS WORK VEHICLE”, filed Feb. 9, 2018, which is hereby incorporated by reference in its entirety.

### BACKGROUND

The disclosure relates generally to a roof assembly for an autonomous work vehicle.

Certain work vehicles, such as tractors or other prime movers, may be controlled by a control system (e.g., without operator input, with limited operator input, etc.) during certain phases of operation. For example, a controller may instruct a steering control system and/or a speed control system of the work vehicle to automatically or semi-automatically guide the work vehicle along a guidance swath through a field. To facilitate control of the work vehicle, the controller may receive position information from a spatial locating device, such as a Global Position System (GPS) receiver. The spatial locating device is typically communicatively coupled to one or more spatial locating antennas (e.g., mounted to an exterior surface of the work vehicle). In addition, the controller may receive information from various obstacle detection sensors, such as LIDAR sensor(s) and/or RADAR sensor(s). Furthermore, the controller may be communicatively coupled to a lighting assembly configured to provide an indication of the operating state of the work vehicle. The spatial locating antenna(s), the obstacle detection sensor(s), and the lighting assembly may be distributed throughout the work vehicle and/or mounted to various components of the work vehicle. Accordingly, the process of manufacturing an autonomous work vehicle and/or converting a manually-controlled work vehicle to an autonomous work vehicle may be complex, time-consuming, and expensive.

### BRIEF DESCRIPTION

In one embodiment, a roof assembly for an autonomous work vehicle includes a roof panel having an outer surface facing an environment external to the autonomous work vehicle. The roof assembly also includes a lighting assembly having at least one light-transmissive panel and at least one multicolor light source. The at least one light-transmissive panel is coupled to the roof panel, the at least one light-transmissive panel has an outer surface facing the environment external to the autonomous work vehicle, the outer surface of the roof panel completely surrounds the outer surface of the at least one light-transmissive panel, and the at least one multicolor light source is configured to emit light through the light-transmissive panel from an inner surface of the light-transmissive panel to the outer surface of the light-transmissive panel. In addition, the at least one multicolor light source is configured to receive a signal from a controller indicative of a selected status indication of a group of status indications and to emit the light based on the selected status indication, the group of status indications correspond to a respective group of operating states of the autonomous work vehicle, and the selected status indication corresponds to a current operating state of the group of operating states.

In another embodiment, a roof assembly for an autonomous work vehicle includes a support structure, at least one spatial locating antenna mounted to the support structure, at least one obstacle detection sensor mounted to the support structure, a communication antenna mounted to the support structure, and a roof panel coupled to the support structure. The roof panel has an outer surface facing an environment external to the autonomous work vehicle, the at least one spatial locating antenna and the communication antenna are positioned within an enclosure formed between the support structure and the roof panel, and the roof panel is formed from a single piece of material.

In a further embodiment, a method of manufacturing a work vehicle includes selecting one roof assembly from a first roof assembly and a second roof assembly. The method also includes coupling the one roof assembly to a frame of a cab of the work vehicle. The one roof assembly is formed before the one roof assembly is coupled to the frame of the cab. In addition, the first roof assembly includes a support structure, at least one spatial locating antenna mounted to the support structure of the first roof assembly, at least one obstacle detection sensor mounted to the support structure of the first roof assembly, a communication antenna mounted to the support structure of the first roof assembly, and a roof panel coupled to the support structure of the first roof assembly. The roof panel of the first roof assembly has an outer surface facing an environment external to the work vehicle, the at least one spatial locating antenna and the communication antenna are positioned within an enclosure formed between the support structure of the first roof assembly and the roof panel of the first roof assembly, and the roof panel of the first roof assembly is formed from a single piece of material. Furthermore, the second roof assembly includes a support structure and a roof panel coupled to the support structure of the second roof assembly. The roof panel of the second roof assembly has an outer surface facing the environment external to the work vehicle, the second roof assembly does not include a spatial locating antenna, and the second roof assembly does not include an obstacle detection sensor.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an autonomous work vehicle having a lighting assembly integrated within a roof assembly;

FIG. 2 is an exploded view of an embodiment of a roof assembly that may be employed within the autonomous work vehicle of FIG. 1;

FIG. 3 is a perspective view of a portion of the roof assembly of FIG. 2;

FIG. 4 is a perspective view of a portion of the roof assembly of FIG. 2, taken within lines 4-4 of FIG. 3;

FIG. 5 is a block diagram of an embodiment of a control system that may be employed within the autonomous work vehicle of FIG. 1; and

FIG. 6 is a flowchart of an embodiment of a method for manufacturing a work vehicle.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

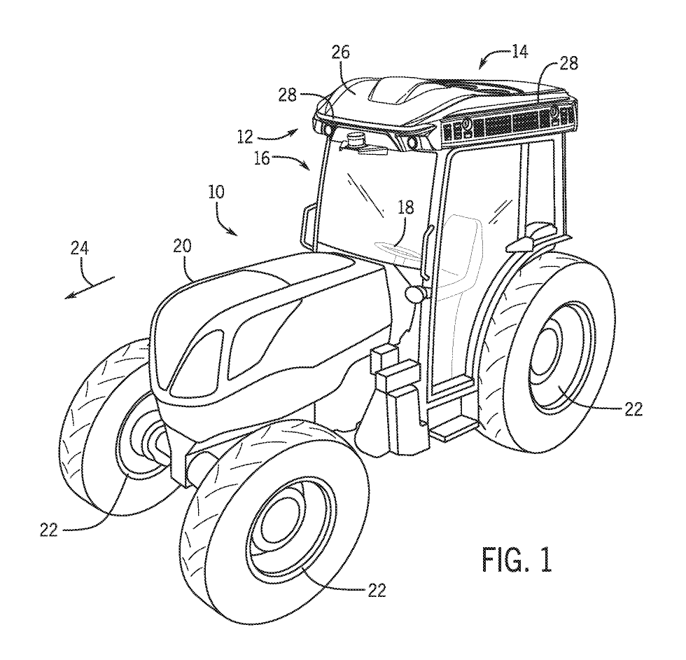

FIG. 1 is a perspective view of an embodiment of an autonomous work vehicle 10 having a lighting assembly 12 integrated within a roof assembly 14. In the illustrated embodiment, the autonomous work vehicle 10 includes a cab 16 configured to house an operator. A steering wheel 18 is disposed within the cab 16 to facilitate control of the autonomous work vehicle 10. The cab may also house additional controls to enable the operator to control various functions of the autonomous work vehicle (e.g., movement of a tool coupled to the autonomous work vehicle, speed of the autonomous work vehicle, etc.). In the illustrated embodiment, the autonomous work vehicle 10 includes a body 20 configured to house an engine, a transmission, other systems of the autonomous work vehicle 10, or a combination thereof. In addition, the autonomous work vehicle 10 includes wheels 22 configured to be driven by the engine, thereby driving the autonomous work vehicle 10 along a field, a road, or any other suitable surface in a direction of travel 24. While the illustrated autonomous work vehicle 10 includes wheels 22, in alternative embodiments, the autonomous work vehicle 10 may include tracks or a combination of wheels and tracks. Furthermore, while the autonomous work vehicle 10 is a tractor in the illustrated embodiment, in other embodiments, the autonomous work vehicle may be a harvester, a sprayer, or any other suitable type of autonomous work vehicle.

In the illustrated embodiment, the roof assembly 14 includes a roof panel 26 having an outer surface facing the environment external to the autonomous work vehicle 10 (e.g., external to the cab 16 of the autonomous work vehicle 10). In addition, the lighting assembly 12 of the roof assembly 14 includes multiple light-transmissive panels 28 and corresponding multicolor light sources. As illustrated, each light-transmissive panel 28 is coupled to the roof panel 26, and the outer surface of the roof panel 26 completely surrounds the outer surface of each light-transmissive panel 28. As discussed in detail below, each multicolor light source is configured to emit light through a respective light-transmissive panel from an inner surface to the outer surface of the light-transmissive panel. Furthermore, each multicolor light source is communicatively coupled to a controller, and the controller is configured to output a signal indicative of a selected status indication to each multicolor light source. Each multicolor light source, in turn, is configured to emit light based on the selected status indication. The controller is configured to select the status indication from a group of status indications, which corresponds to a respective group of operating states of the autonomous work vehicle, based on a current operating state of the autonomous work vehicle. Because the lighting assembly 12 is integrated within the roof assembly 14, the manufacturing cost of the autonomous work vehicle may be reduced and/or the appearance of the autonomous work vehicle may be enhanced (e.g., as compared to an autonomous work vehicle that includes a lighting assembly mounted above the roof panel).

In certain embodiments, the roof assembly includes a support structure, spatial locating antenna(s) mounted to the support structure, obstacle detection sensor(s) mounted to the support structure, and a communication antenna mounted to the support structure. In addition, the roof panel is coupled to the support structure, and the roof panel is formed from a single piece of material. The spatial locating antenna(s) and the communication antenna are positioned within an enclosure formed between the support structure and the roof panel, thereby concealing the antennas from an observer positioned outside the autonomous work vehicle. Accordingly, the appearance of the autonomous work vehicle may be enhanced, as compared to an autonomous work vehicle that includes one or more antennas mounted outside (e.g., to a top surface of) a roof assembly. In addition, because at least a portion, if not all, of the sensors and antennas sufficient to facilitate autonomous operation of the autonomous work vehicle are mounted to the support structure of the roof assembly, the duration, cost, and/or complexity of manufacturing the autonomous work vehicle may be reduced, as compared to an autonomous work vehicle that includes sensor(s) and/or antenna(s) distributed throughout the autonomous work vehicle and/or mounted to various components of the autonomous work vehicle. For example, in certain embodiments of the present disclosure, the roof assembly may be manufacturing as a single unit and then coupled to a frame of the autonomous work vehicle cab.

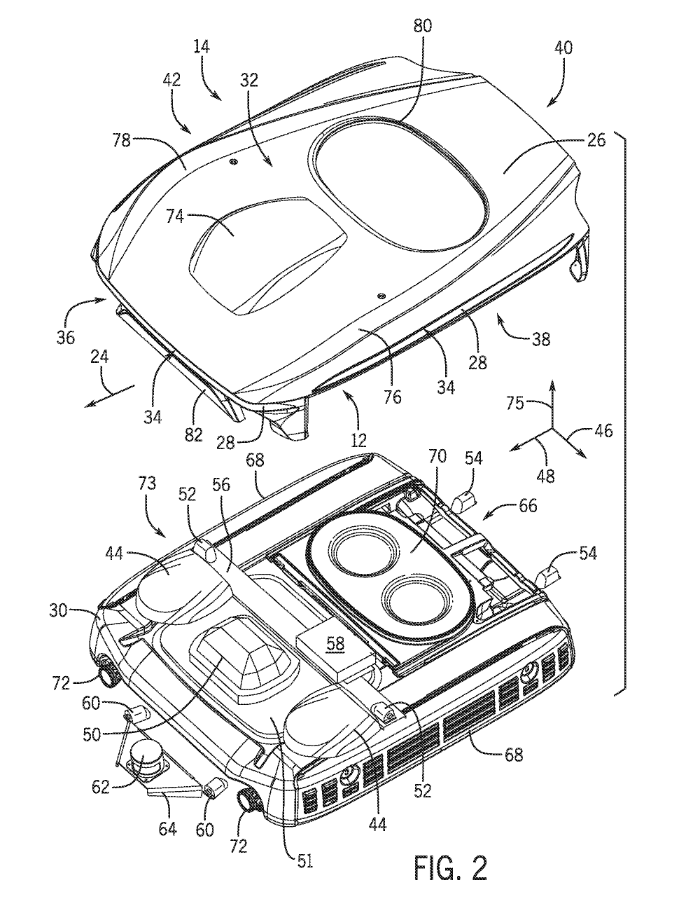

FIG. 2 is an exploded view of an embodiment of a roof assembly 14 that may be employed within the autonomous work vehicle of FIG. 1. In the illustrated embodiment, the roof assembly 14 includes a support structure 30, and the roof panel 26 is coupled to the support structure (e.g., by fasteners, by latches, etc.). As illustrated, the roof panel 26 has an outer surface 32 facing the environment external to the autonomous work vehicle (e.g., external to the cab of the autonomous work vehicle). Furthermore, as previously discussed, the lighting assembly 12 of the roof assembly 14 includes light-transmissive panels 28 and multicolor light sources. Each light-transmissive panel 28 is coupled to the roof panel 26, and each light-transmissive panel 28 has an outer surface 34 facing the environment external to the autonomous work vehicle. As illustrated, the outer surface 32 of the roof panel 26 completely surrounds the outer surface 34 of each light-transmissive panel 28, and each multicolor light source is configured to emit light through a respective light-transmissive panel 28 from an inner surface of the light-transmissive panel 28 to the outer surface 34 of the light-transmissive panel 28. While the outer surface of the roof panel completely surrounds the outer surface of each light-transmissive panel in the illustrated embodiment, in other embodiments, the outer surface of the roof panel may only partially surround the outer surface of at least one light-transmissive panel.

In the illustrated embodiment, each light-transmissive panel 28 is formed from a translucent material. Accordingly, the light-transmissive panel may diffuse the light emitted from the respective multicolor light source. For example, at least one light-transmissive panel may be formed from a tinted/frosted polymeric material (e.g., polycarbonate, acrylic, etc.). In further embodiments, at least one light-transmissive panel may be formed from a substantially clear material, and/or a coating layer (e.g., paint, film, etc.) may be applied to at least one light-transmissive panel (e.g., a light-transmissive panel formed from a substantially clear material).

In the illustrated embodiment, the roof assembly 14 includes a first light-transmissive panel 28 positioned on a front side 36 of the roof panel 26, a second light-transmissive panel 28 positioned on a left side 38 of the roof assembly 14, a third light-transmissive panel 28 positioned on a rear side 40 of the roof assembly 14, and a fourth light-transmissive panel 28 positioned on a right side 42 of the roof assembly 14. In certain embodiments, a multicolor light source is positioned behind each light-transmissive panel. In the illustrated embodiment, the first light-transmissive panel 28 extends from the front side 36 of the roof assembly 14 to the left side 38 and the right side 42 of the roof assembly 14. However, in alternative embodiments, the first light-transmissive panel may extend only along the front side, only along the front side and the left side, only along the front side and the right side, or along the front side, the left side, the rear side, and the right side. In addition, while the second light-transmissive panel 28 only extends along the left side 38 in the illustrated embodiment, in other embodiments, the second light-transmissive panel may extend along any suitable combination of sides. Because the lighting assembly 12 is integrated within the roof assembly 14, the manufacturing cost of the autonomous work vehicle may be reduced and/or the appearance of the autonomous work vehicle may be enhanced (e.g., as compared to an autonomous work vehicle that includes a lighting assembly mounted above the roof panel).

Each multicolor light source is configured to emit light through the respective light-transmissive panel 28 from the inner surface to the outer surface 34 of the light-transmissive panel 28. Furthermore, each multicolor light source is communicatively coupled to a controller, and the controller is configured to output a signal indicative of a selected status indication to each multicolor light source. Each multicolor light source, in turn, is configured to emit light based on the selected status indication. The controller is configured to select the status indication from a group of status indications, which corresponds to a respective group of operating states of the autonomous work vehicle, based on a current operating state of the autonomous work vehicle. Accordingly, a person positioned outside the autonomous work vehicle may identify the current operating state of the autonomous work vehicle by observing the light emitted from the lighting assembly 12.

In the illustrated embodiment, the roof assembly 14 includes two spatial locating antennas 44 mounted to the support structure 30. The illustrated spatial locating antennas 44 are directly coupled to the support structure 30 (e.g., via fasteners, etc.). However, in alternative embodiments, the spatial locating antennas may be coupled to the support structure by a suitable mount/structure. As illustrated, a first spatial locating antenna 44 is positioned on the left side 38 of the roof assembly 14, and a second spatial locating antenna 44 is positioned on the right side 42 of the roof assembly 14. Each spatial locating antenna 44 is configured to receive spatial locating signals (e.g., GPS signals from GPS satellites) and to output corresponding spatial locating data to a spatial locating device. The spatial locating device is configured to determine the position of each spatial locating antenna (e.g., based at least in part on the spatial locating data). The spatial locating device and/or a controller communicatively coupled to the spatial locating device is configured to determine the position and orientation of the autonomous work vehicle based at least in part on the position of each spatial locating antenna. While the spatial locating antennas 44 are positioned on opposite lateral sides of the roof assembly 14 (e.g., opposite sides along a lateral axis 46) in the illustrated embodiment, in other embodiments, the spatial locating antennas may be positioned on opposite longitudinal sides of the roof assembly (e.g., opposite sides along a longitudinal axis 48) or at any other suitable location(s) within the roof assembly. In addition, while the illustrated roof assembly 14 includes two spatial locating antennas 44, in alternative embodiments the roof assembly may include more or fewer spatial locating antennas (e.g., 0, 1, 2, 3, 4, 5, 6, or more). Furthermore, in certain embodiments, at least one spatial locating antenna may be positioned remote from the roof assembly (e.g., mounted to the body of the autonomous work vehicle).

In the illustrated embodiment, the roof assembly includes a communication antenna 50 mounted to the support structure 30 via a mounting plate 51. However, in other embodiments, the communication antenna may be directly coupled to the support structure, or the communication antenna may be mounted to the support structure by another suitable support/mount. The communication antenna 50 is communicatively coupled to a communication transceiver, which may be mounted to the roof assembly or positioned remote from the roof assembly. The transceiver is configured to establish a communication link with a corresponding transceiver of a base station and/or another work vehicle, thereby facilitating communication between the autonomous work vehicle and the base station/other work vehicle. While the communication antenna 50 is mounted between the spatial locating antennas 44 along the lateral axis 46 in the illustrated embodiment, in other embodiments, the communication antenna may be positioned at any other suitable location within the roof assembly. In addition, while the illustrated roof assembly 14 includes a single communication antenna 50, in alternative embodiments, the roof assembly may include more or fewer communication antennas (e.g., 0, 1, 2, 3, 4, 5, 6, or more). Furthermore, in certain embodiments, at least one communication antenna may be positioned remote from the roof assembly (e.g., mounted to the body of the autonomous work vehicle).

The roof assembly 14 includes multiple obstacle detection sensors. In the illustrated embodiment, the obstacle detection sensors include two side-mounted cameras 52 and two rear-mounted cameras 54. Each side-mounted camera 52 is mounted to the support structure 30 via a lateral bar 56. However, in other embodiments, the side-mounted cameras may be directly coupled to the support structure, or the side-mounted cameras may be mounted to the support structure by another suitable support/mount. Furthermore, the illustrated rear-mounted cameras 54 are directly coupled to the support structure 30 (e.g., via fasteners, etc.). However, in alternative embodiments, the rear-mounted cameras may be coupled to the support structure by a suitable mount/structure. In the illustrated embodiment, each camera is communicatively coupled to a video encoder 58, which is configured to encode a video signal from the cameras and to output an encoded video signal to a controller. The controller, in turn, is configured to identify obstacle(s) (e.g., the location of the obstacle(s), the distance from the autonomous work vehicle to the obstacle(s), the size and/or shape of the obstacle(s), etc.) based on the encoded video signal. In the illustrated embodiment, the video encoder 58 is mounted to the support structure 30 via the lateral bar 56. However, in alternative embodiments, the video encoder may be directly coupled to the support structure, or the video encoder may be mounted to the support structure by another suitable support/mount. In further embodiments, the video encoder may be mounted remote from the roof assembly.

As illustrated, the side-mounted cameras 52 are directed outwardly from the support structure 30 along the lateral axis 46, and the rear-mounted cameras 54 are directed rearwardly along the longitudinal axis 48 relative to the direction of travel 24. However, in alternative embodiments, each camera may be directed in any suitable direction to facilitate detection of obstacles. In addition, while one side-mounted camera 52 is positioned on the left side 38 of the roof assembly 14, and one side-mounted camera 52 is positioned on the right side 42 of the roof assembly 14, in alternative embodiments, any suitable number of side-mounted cameras may be positioned on each lateral side of the roof assembly (e.g., 0, 1, 2, 3, 4, 5, 6, or more). Furthermore, while two rear-mounted cameras 54 are positioned on the rear side 40 of the roof assembly 14, in alternative embodiments, more or fewer rear-mounted cameras may be positioned on the rear side of the roof assembly (e.g., 0, 1, 2, 3, 4, 5, 6, or more). While each side-mounted camera 52 and each rear-mounted camera 54 is mounted to the support structure 30 in the illustrated embodiment, in other embodiments, at least one camera may be mounted to another structure of the autonomous work vehicle, such as a frame of a cab of the autonomous work vehicle.

In certain embodiments, front-mounted cameras 60 are mounted to the frame of the cab of the autonomous work vehicle. However, in other embodiments, the front-mounted cameras are mounted to the support structure of the roof assembly. Each front-mounted camera 60 is communicatively coupled to the video encoder 58. As previously discussed, the video encoder 58 is configured to receive a video signal from each camera and to output an encoded video signal to a controller. The controller, in turn, is configured to identify obstacle(s) (e.g., the location of the obstacle(s), the distance from the autonomous work vehicle to the obstacle(s), the size and/or shape of the obstacle(s), etc.) based on the encoded video signal. As illustrated, the front-mounted cameras 60 are directed forwardly along the longitudinal axis 48 relative to the direction of travel 24. However, in alternative embodiments, each front-mounted camera 60 may be directed in any suitable direction to facilitate detection of obstacles. In addition, while two front-mounted cameras 60 are positioned on the front side 36 of the roof assembly 14, in alternative embodiments, more or fewer front-mounted cameras may be positioned on the front side of the roof assembly (e.g., 0, 1, 2, 3, 4, 5, 6, or more).

In certain embodiments, a LIDAR sensor 62 is mounted to the frame of the cab of the autonomous work vehicle by a mounting plate 64. In other embodiments, the LIDAR sensor 62 may be mounted to the frame of the cab directly or by another suitable mount/structure. In further embodiments, the LIDAR sensor may be mounted to the support structure of the roof assembly. The LIDAR sensor is configured to emit laser radiation, to receive a return signal from the laser radiation, and to output an output signal to a controller based on the return signal. The controller, in turn, is configured to identify obstacle(s) (e.g., the location of the obstacle(s), the distance from the autonomous work vehicle to the obstacle(s), the size and/or shape of the obstacle(s), etc.) based on the output signal. As illustrated, the LIDAR sensor 62 is directed outwardly from the support structure 30 along the longitudinal axis 48. However, in alternative embodiments, the LIDAR sensor 62 may be directed in any suitable direction to facilitate detection of obstacles. In addition, while one LIDAR sensor 62 is positioned on the front side 36 of the roof assembly 14 in the illustrated embodiment, in alternative embodiments, more or fewer LIDAR sensors (e.g., 0, 1, 2, 3, 4, 5, 6, or more) may be positioned at any suitable location(s) on the roof assembly and/or remote from the roof assembly.

While the illustrated obstacle detection sensors include cameras and a LIDAR sensor, in other embodiments, the obstacle detection sensors may include other and/or additional obstacle detection sensors. For example, in certain embodiments, the obstacles detection sensors may include RADAR sensor(s), proximity sensor(s), passive infrared sensor(s), active infrared sensor(s), ultrasonic sensor(s), other suitable obstacle detection sensor(s), or a combination thereof. In certain embodiments, the roof assembly may not include an obstacle detection sensor mounted to the support structure (e.g., in embodiments in which one or more obstacle detection sensors are mounted to other location(s) on the autonomous work vehicle, such as the frame of the cab).

In the illustrated embodiment, the roof assembly 14 includes a heating, ventilation, and air-conditioning (HVAC) assembly 66 mounted to the support structure 30. As illustrated, vent panels 68 are coupled to the support structure 30 and include vents configured to facilitate airflow into the HVAC assembly 66. In certain embodiments, at least one vent panel 68 may be removed or moved to an open position to facilitate access to certain components of the HVAC assembly 66 (e.g., air filter(s), etc.). In the illustrated embodiment, a portion of the HVAC assembly 66 is covered with a cover panel 70, which is coupled to the support structure 30.

Furthermore, in the illustrated embodiment, the roof assembly 14 includes auxiliary lights 72. The auxiliary lights 72 are mounted to the support structure 30 of the roof assembly 14. As illustrated, the auxiliary lights 72 are directed outwardly from the support structure 30 along the longitudinal axis 48. However, in alternative embodiments, each auxiliary light may be directed in any suitable direction to provide illumination for the camera(s) and/or operator of the autonomous work vehicle. In addition, while two auxiliary lights 72 are positioned on the front side 36 of the roof assembly 14 in the illustrated embodiment, in alternative embodiments, more or fewer auxiliary lights (e.g., 0, 1, 2, 3, 4, 5, 6, or more) may be positioned at any suitable location(s) on the roof assembly and/or remote from the roof assembly. For example, in certain embodiments, at least one auxiliary light may be mounted to the frame of the cab of the autonomous work vehicle.

As previously discussed, the roof panel 26 is coupled to the support structure 30. The shape of the roof panel 26 is configured to establish an enclosure 73 between the support structure 30 and the roof panel 26. In the illustrated embodiment, the spatial locating antennas 44, the communication antenna 50, and the video encoder 58 are positioned within the enclosure 73. As illustrated, the roof panel 26 includes a first raised portion 74 positioned above the communication antenna 50 along a vertical axis 75 and configured to accommodate the communication antenna 50. The roof panel 26 also includes a second raised portion 76 on the left side 38 of the roof assembly 14 positioned above one spatial locating antenna 44 along the vertical axis 75 and configured to accommodate the spatial locating antenna 44, and the roof panel 26 includes a third raised portion 78 on the right side 42 of the roof assembly 14 positioned above the other spatial locating antenna 44 along the vertical axis 75 and configured to accommodate the other spatial locating antenna 44. In addition, the roof panel 26 has an opening 80 configured to facilitate passage of the HVAC cover panel 70. While the spatial locating antennas, the communication antenna, and the video encoder are disposed within the enclosure in the illustrated embodiment, in other embodiments, other and/or additional components may be disposed within the enclosure, and/or at least one antenna and/or the video encoder may be positioned outside the enclosure.

In the illustrated embodiment, the roof assembly 14 includes a light-transmissive panel 82 coupled to the roof panel 26. The light-transmissive panel 82 is configured to be positioned in front of the front-mounted cameras 60 (e.g., behind the LIDAR sensor 62 relative to the longitudinal axis 48) to block debris from impacting the front-mounted cameras. In certain embodiments, the light-transmissive panel 82 is substantially clear. Furthermore, in certain embodiments, the light-transmissive panel may be tinted, and/or a tinting film may be disposed on at least one side of the light-transmissive panel. In further embodiments, the light-transmissive panel may be omitted.

In certain embodiments, the support structure 30 is formed from a single piece of material (e.g., a polymeric material). For example, the support structure 30 may be formed by a rotational molding process. Furthermore, in certain embodiments, the roof panel 26 is formed from a single piece of material (e.g., polymeric material). For example, the roof panel 26 may be formed by a rotational molding process. However, in other embodiments, the support structure and/or the roof panel may be formed from multiple components coupled to one another. In addition, in certain embodiments, the roof panel is formed from a material that facilitates passage of spatial locating signals to the spatial locating antenna(s) and facilitates passages of communication signals to the communication antenna.

Because the spatial locating antenna(s) and the communication antenna are positioned within the enclosure formed between the support structure and the roof panel, the antennas are concealed from an observer positioned outside the autonomous work vehicle. Accordingly, the appearance of the autonomous work vehicle may be enhanced, as compared to an autonomous work vehicle that includes one or more antennas mounted outside (e.g., to a top surface of) a roof assembly. In addition, because at least a portion, if not all, of the sensors and antennas sufficient to facilitate autonomous operation of the autonomous work vehicle are mounted to the support structure of the roof assembly, the duration, cost, and/or complexity of manufacturing the autonomous work vehicle may be reduced, as compared to an autonomous work vehicle that includes sensor(s) and/or antenna(s) distributed throughout the autonomous work vehicle and/or mounted to various components of the autonomous work vehicle. For example, in certain embodiments of the present disclosure, the roof assembly may be manufacturing as a single unit and then coupled to the frame of the autonomous work vehicle cab.

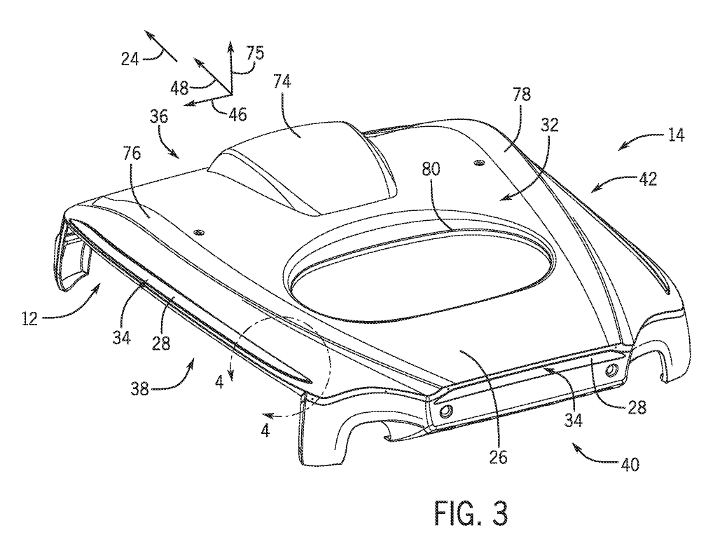

FIG. 3 is a perspective view of a portion of the roof assembly 14 of FIG. 2. In the illustrated embodiment, the third light-transmissive panel 28 only extends along the rear side 40 of the roof assembly 14. However, in alternative embodiments, the third light-transmissive panel may extend along any suitable combination of sides of the roof assembly. In addition, the fourth light-transmissive panel 28 only extends along the right side 42 of the roof assembly 14 in the illustrated embodiment. However, in alternative embodiments, the fourth light-transmissive panel may extend along any suitable combination of sides of the roof assembly. While the illustrated roof assembly includes four light-transmissive panels, in alternative embodiments, the roof assembly may include more or fewer light-transmissive panels (e.g., 0, 1, 2, 3, 4, 5, 6, 7, 8, 9, 10, or more). Furthermore, each light-transmissive panel may be positioned in any suitable location and/or may have any suitable shape that enables a person positioned outside the autonomous work vehicle to identify the current operating state of the autonomous work vehicle by observing the light emitted from the lighting assembly 12. Because the lighting assembly 12 is integrated within the roof assembly 14, the manufacturing cost of the autonomous work vehicle may be reduced and/or the appearance of the autonomous work vehicle may be enhanced (e.g., as compared to an autonomous work vehicle that includes a lighting assembly mounted above the roof panel).

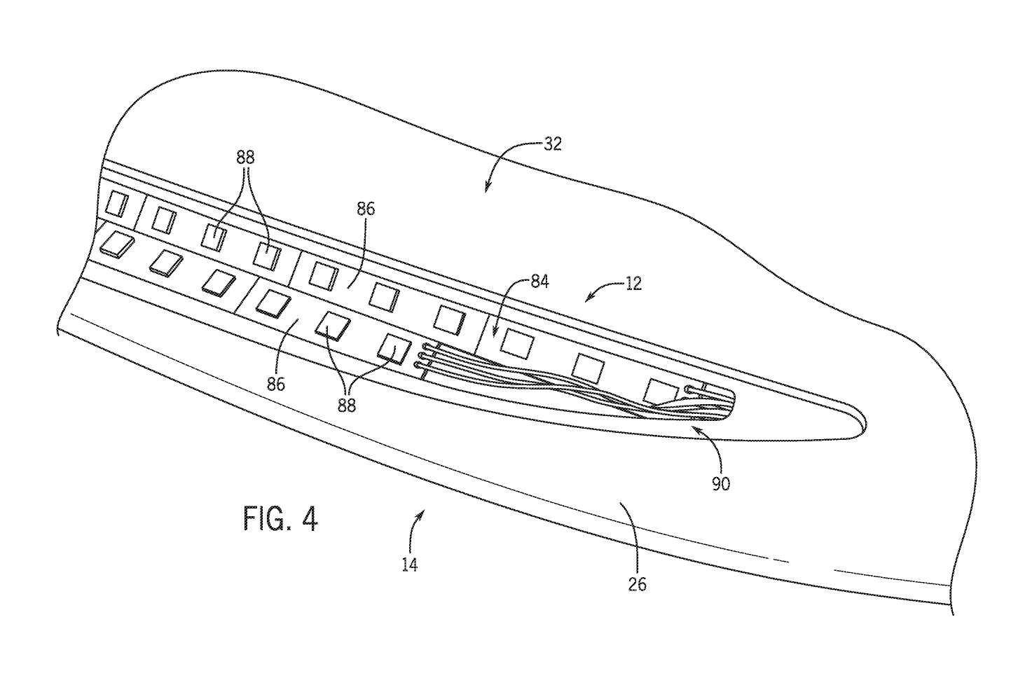

FIG. 4 is a perspective view of a portion of the roof assembly 14 of FIG. 2, taken within lines 4-4 of FIG. 3. As illustrated, the light-transmissive panel is removed to expose the multicolor light source 84. In the illustrated embodiment, the multicolor light source 84 includes circuit boards 86 coupled to the roof panel 26 behind the inner surface of the respective light-transmissive panel. Multiple light-emitting diode (LED) assemblies 88 are coupled to each circuit board 86. Each LED assembly 88 is configured to emit light of a selected color (e.g., based on a signal from a controller) through the respective light-transmissive panel from the inner surface of the light-transmissive panel to the outer surface of the light-transmissive panel, thereby illuminating the respective light-transmissive panel. In the illustrated embodiment, the multicolor light source 84 includes two rows of circuit boards 86 that are slightly angled toward one another. However, in alternative embodiments, the multicolor light source may include any suitable arrangement of circuit boards. Furthermore, while the illustrated multicolor light source includes LED assemblies mounted to circuit boards, in other embodiments, the multicolor light source may include LED assemblies mounted to flex circuits, one or more incandescent and/or fluorescent bulbs, any other suitable type(s) of light emitted device(s), or a combination thereof. While a single multicolor light source is positioned behind the respective light-transmissive panel in the illustrated embodiment, in other embodiments, multiple multicolor light sources may be positioned behind at least one light-transmissive panel, and/or a single light source may be used to illuminate multiple light-transmissive panels (e.g., via fiber optic connection(s), via light guide connection(s), etc.). Furthermore, while the illustrated embodiment includes a multicolor light source, in other embodiments, the light source may be a unicolor light source (e.g., in embodiments in which the lighting assembly is configured to convey the operating state of the autonomous work vehicle to an observer by using a flashing light pattern, etc.).

In the illustrated embodiment, the multicolor light source 84 is communicatively coupled to a controller by a wiring assembly 90. The controller is configured to output a signal indicative of a selected status indication to each multicolor light source. Each multicolor light source, in turn, is configured to emit light based on the selected status indication (e.g., such that each multicolor light source is emitting light of substantially the same color and/or pattern). The controller is configured to select the status indication from a group of status indications, which corresponds to a respective group of operating states of the autonomous work vehicle, based on a current operating state of the autonomous work vehicle. Because the lighting assembly is integrated within the roof assembly, the manufacturing cost of the autonomous work vehicle may be reduced and/or the appearance of the autonomous work vehicle may be enhanced (e.g., as compared to an autonomous work vehicle that includes a lighting assembly mounted above the roof panel).

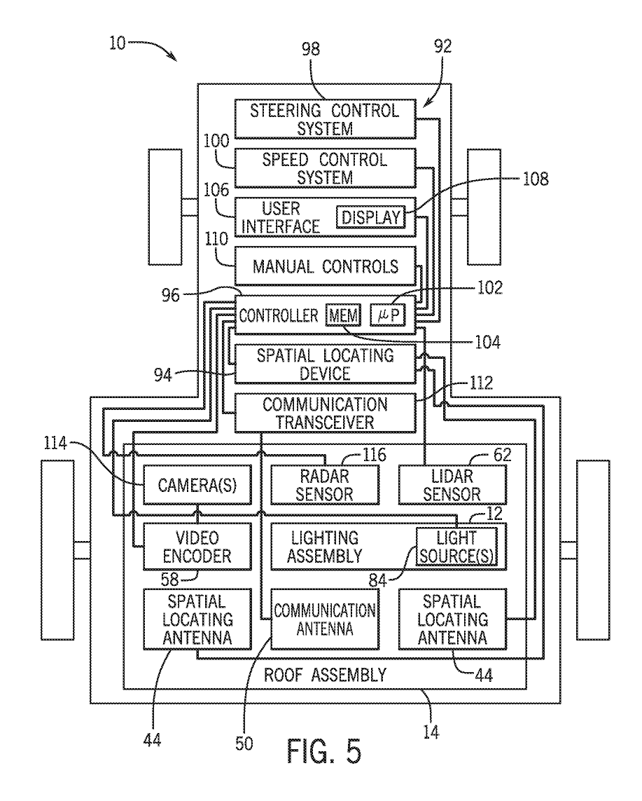

FIG. 5 is a block diagram of an embodiment of a control system 92 that may be employed within the autonomous work vehicle 10 of FIG. 1. In the illustrated embodiment, the control system 92 includes a spatial locating device 94, which is mounted to the autonomous work vehicle 10 and configured to determine a position, and in certain embodiments a velocity, of the autonomous work vehicle 10. The spatial locating device 94 may include any suitable system configured to measure and/or determine the position of the autonomous work vehicle 10, such as a GPS receiver, for example.

In the illustrated embodiment, the control system 92 also includes the first spatial locating antenna 44 and the second spatial locating antenna 44, each communicatively coupled to the spatial locating device 94. Each spatial locating antenna 44 is configured to receive spatial locating signals (e.g., GPS signals from GPS satellites) and to output corresponding spatial locating data to the spatial locating device 94. As previously discussed, the spatial locating antennas 44 are positioned on opposite lateral sides of the roof assembly 14. The spatial locating device 94 is configured to determine the position of each spatial locating antenna 44 (e.g., based at least in part on the spatial locating signals). The spatial locating device 94 and/or a controller 96 of the control system 92 is configured to determine the orientation of the autonomous work vehicle 10 based at least in part on the position of each spatial locating antenna. While the illustrated control system 92 includes two spatial locating antennas 44, in alternative embodiments, the control system may include more or fewer spatial locating antennas (e.g., 0, 1, 2, 3, 4, 5, 6, or more). Furthermore, in certain embodiments, the spatial locating device is coupled to the support structure of the roof assembly (e.g., adjacent to the spatial locating antennas). For example, in certain embodiments, a first portion of the spatial locating device may be integrated with the first spatial locating antenna, and a second portion of the spatial locating device may be integrated with the second spatial locating antenna. In other embodiments, the spatial locating device may be positioned remote from the roof assembly.

In the illustrated embodiment, the control system 92 includes a steering control system 98 configured to control a direction of movement of the autonomous work vehicle 10, and a speed control system 100 configured to control a speed of the autonomous work vehicle 10. In addition, the control system 92 includes the controller 96, which is communicatively coupled to the spatial locating device 94, to the steering control system 98, and to the speed control system 100. The controller 96 is configured to automatically control the autonomous work vehicle at least during certain phases of agricultural operations (e.g., without operator input, with limited operator input, etc.). In certain embodiments, the controller is coupled to the support structure of the roof assembly. However, in other embodiments, the controller may be positioned at any suitable location throughout the autonomous work vehicle.

In certain embodiments, the controller 96 is an electronic controller having electrical circuitry configured to process data from the spatial locating device 94 and/or other components of the control system 92. In the illustrated embodiment, the controller 96 include a processor, such as the illustrated microprocessor 102, and a memory device 104. The controller 96 may also include one or more storage devices and/or other suitable components. The processor 102 may be used to execute software, such as software for controlling the autonomous work vehicle, software for controlling the lighting assembly 12, and so forth. Moreover, the processor 102 may include multiple microprocessors, one or more “general-purpose” microprocessors, one or more special-purpose microprocessors, and/or one or more application specific integrated circuits (ASICS), or some combination thereof. For example, the processor 102 may include one or more reduced instruction set (RISC) processors.

The memory device 104 may include a volatile memory, such as random access memory (RAM), and/or a nonvolatile memory, such as read-only memory (ROM). The memory device 104 may store a variety of information and may be used for various purposes. For example, the memory device 104 may store processor-executable instructions (e.g., firmware or software) for the processor 102 to execute, such as instructions for controlling the autonomous work vehicle 10, instructions for controlling the lighting assembly 12, and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the autonomous work vehicle, etc.), and any other suitable data.

In certain embodiments, the steering control system 98 may include a wheel angle control system, a differential braking system, a torque vectoring system, or a combination thereof. The wheel angle control system may automatically rotate one or more wheels and/or tracks of the autonomous work vehicle (e.g., via hydraulic actuators) to steer the autonomous work vehicle along a target route (e.g., along a guidance swath, along headline turns, etc.). By way of example, the wheel angle control system may rotate front wheels/tracks, rear wheels/tracks, intermediate wheels/tracks, or a combination thereof, of the autonomous work vehicle (e.g., either individually or in groups). The differential braking system may independently vary the braking force on each lateral side of the autonomous work vehicle to direct the autonomous work vehicle along a path. In addition, the torque vectoring system may differentially apply torque from an engine to wheel(s) and/or track(s) on each lateral side of the autonomous work vehicle, thereby directing the autonomous work vehicle along a path. In further embodiments, the steering control system may include other and/or additional systems to facilitate directing the autonomous work vehicle along a path through the field.

In certain embodiments, the speed control system 100 may include an engine output control system, a transmission control system, a braking control system, or a combination thereof. The engine output control system may vary the output of the engine to control the speed of the autonomous work vehicle. For example, the engine output control system may vary a throttle setting of the engine, a fuel/air mixture of the engine, a timing of the engine, other suitable engine parameters to control engine output, or a combination thereof. In addition, the transmission control system may adjust a gear ratio of a transmission (e.g., by adjusting gear selection in a transmission with discrete gears, by controlling a continuously variable transmission (CVT), etc.) to control the speed of the autonomous work vehicle. Furthermore, the braking control system may adjust braking force, thereby controlling the speed of the autonomous work vehicle. In further embodiments, the speed control system may include other and/or additional systems to facilitate adjusting the speed of the autonomous work vehicle.

In certain embodiments, the control system may also control operation of an agricultural implement coupled to the autonomous work vehicle. For example, the control system may include an implement control system/implement controller configured to control a steering angle of the implement (e.g., via an implement steering control system having a wheel angle control system and/or a differential braking system) and/or a speed of the autonomous work vehicle system (e.g., via an implement speed control system having a braking control system). In such embodiments, the autonomous work vehicle control system may be communicatively coupled to a control system/controller on the implement via a communication network, such as a controller area network (CAN bus).

In the illustrated embodiment, the control system 92 includes a user interface 106 communicatively coupled to the controller 96. The user interface 106 is configured to enable an operator to control certain parameter(s) associated with operation of the autonomous work vehicle 10. For example, the user interface 106 may include a switch that enables the operator to selectively configure the autonomous work vehicle for autonomous or manual operation. In addition, the user interface 106 may include a battery cut-off switch, an engine ignition switch, a stop button, or a combination thereof, among other controls. In certain embodiments, the user interface 106 includes a display 108 configured to present information to the operator, such as a graphical representation of a swath, a visual representation of certain parameter(s) associated with operation of the autonomous work vehicle (e.g., fuel level, oil pressure, water temperature, etc.), a visual representation of certain parameter(s) associated with operation of the agricultural implement coupled to the autonomous work vehicle (e.g., product flow rate, product quantity remaining in tank, penetration depth of ground engaging tools, orientation(s)/position(s) of certain components of the implement, etc.), or a combination thereof, among other information. In certain embodiments, the display 108 may include a touch screen interface that enables the operator to control certain parameters associated with operation of the autonomous work vehicle and/or the agricultural implement. For example, the touch screen interface may enable an operator to manually control the lighting assembly 12 (e.g., the status indication presented by the lighting assembly 12, etc.).

In the illustrated embodiment, the control system 96 includes manual controls 110 configured to enable an operator to control the autonomous work vehicle while automatic control is disengaged (e.g., while unloading the autonomous work vehicle from a trailer, etc.). The manual controls 110 may include manual steering control, manual transmission control, manual braking control, or a combination thereof, among other controls. In the illustrated embodiment, the manual controls 110 are communicatively coupled to the controller 96. The controller 96 is configured to disengage automatic control of the autonomous work vehicle upon receiving a signal indicative of manual control of the autonomous work vehicle. Accordingly, if an operator controls the autonomous work vehicle manually, the automatic control terminates, thereby enabling the operator to control the autonomous work vehicle.

In the illustrated embodiment, the control system 92 includes a communication transceiver 112 communicatively coupled to the controller 96 and to the communication antenna 50. In certain embodiments, the communication transceiver 112 is configured to establish a communication link with a corresponding transceiver of a base station and/or another work vehicle via the communication antenna 50, thereby facilitating communication between the base station/other work vehicle and the control system of the autonomous work vehicle. For example, the base station may include a user interface that enables a remote operator to provide instructions to the control system (e.g., instructions to initiate automatic control of the autonomous work vehicle, instructions to direct the autonomous work vehicle along a route, etc.). The user interface may also enable a remote operator to provide data to the control system. The communication transceiver 112 and the corresponding communication antenna 50 may operate at any suitable frequency range within the electromagnetic spectrum. For example, in certain embodiments, the communication transceiver 112 may broadcast and receive radio waves within a frequency range of about 1 GHz to about 10 GHz. In addition, the communication transceiver 112 may utilize any suitable communication protocol, such as a standard protocol (e.g., Wi-Fi, Bluetooth, etc.) or a proprietary protocol. In certain embodiments, the communication transceiver is coupled to the support structure of the roof assembly (e.g., adjacent to the communication antenna). For example, in certain embodiments, the communication transceiver may be integrated with the communication antenna. In other embodiments, the communication transceiver may be positioned remote from the roof assembly.

In certain embodiments, the control system may include other and/or additional controllers/control systems, such as the implement controller/control system discussed above. For example, the implement controller/control system may be configured to control various parameters of an agricultural implement towed by the autonomous work vehicle. In certain embodiments, the implement controller/control system may be configured to control product flow from the implement to the soil. Furthermore, the implement controller/control system may instruct actuator(s) to transition the agricultural implement between a working position and a transport portion, to control a penetration depth of a ground engaging tool, or to adjust a position of a header of the agricultural implement (e.g., a harvester, etc.), among other operations. The autonomous work vehicle control system may also include controller(s)/control system(s) for electrohydraulic remote(s), power take-off shaft(s), adjustable hitch(es), or a combination thereof, among other controllers/control systems.

In the illustrated embodiment, the control system 92 includes multiple obstacle detection sensors. The obstacle detection sensors include camera(s) 114, such as the side-mounted camera(s), the rear-mounted camera(s), the front-mounted camera(s), or a combination thereof. As illustrated, the camera(s) 114 are communicatively coupled to the video encoder 58, and the video encoder 58 is communicatively coupled to the controller 96. Each camera 114 is configured to output a video signal to the video encoder 58, and the video encoder 58, in turn, is configured to encode the video signal and to output an encoded video signal to the controller 96. The controller 96 is configured to identify obstacle(s) (e.g., the location of the obstacle(s), the distance from the autonomous work vehicle to the obstacle(s), the size and/or shape of the obstacle(s), etc.) based on the encoded video signal. In the illustrated embodiment, the combination of one camera and the video encoder forms an obstacle detection sensor. Accordingly, an embodiment employing six cameras and one video encoder includes six obstacle detection sensors (e.g., in addition to any non-camera based obstacle detection sensor(s)). Furthermore, in certain embodiments, the video encoder may be omitted, or a video encoder may be integrated within at least one camera. In such embodiments, a camera (e.g., with or without an integrated video encoder) that is directly communicatively coupled to the controller is considered an obstacle detection sensor.

In the illustrated embodiment, the obstacle detection sensors include the LIDAR sensor 62. As illustrated, the LIDAR sensor 62 is communicatively coupled to the controller 96. As previously discussed, the LIDAR sensor is configured to emit laser radiation, to receive a return signal from the laser radiation, and to output an output signal to the controller 96 based on the return signal. The controller 96 is configured to identify obstacle(s) (e.g., the location of the obstacle(s), the distance from the autonomous work vehicle to the obstacle(s), the size and/or shape of the obstacle(s), etc.) based on the output signal.

In the illustrated embodiment, the obstacle detection sensors include a radio detection and ranging (RADAR) sensor 116. As illustrated, the RADAR sensor 116 is communicatively coupled to the controller 96. The RADAR sensor is configured to emit electromagnetic radiation (e.g., within radio wavelengths, within microwave wavelengths, etc.), to receive a return signal from the electromagnetic radiation, and to output an output signal to the controller 96 based on the return signal. The controller 96 is configured to identify obstacle(s) (e.g., the location of the obstacle(s), the distance from the autonomous work vehicle to the obstacle(s), the size and/or shape of the obstacle(s), etc.) based on the output signal.

While the obstacle detection sensors include camera(s), a LIDAR sensor, and a RADAR sensor in the illustrated embodiment, in other embodiments, the obstacle detection sensors may include other and/or additional suitable obstacle detection sensors, such as proximity sensor(s), passive infrared sensor(s), active infrared sensor(s), and ultrasonic sensor(s). Furthermore, while the illustrated embodiment includes a single LIDAR sensor, in other embodiments, the obstacle detection sensors may include 0, 1, 2, 3, 4, or any other suitable number of LIDAR sensors. In addition, while the illustrated embodiment includes a single RADAR sensor, in other embodiments, the obstacle detection sensors may include 0, 1, 2, 3, 4, or any other suitable number of RADAR sensors. In certain embodiments, at least one obstacle detection sensor is coupled to the support structure of the roof assembly. For example, one or more obstacle detection sensors may be mounted to the support structure of the roof assembly, and one or more other obstacle detection sensors may be mounted to other suitable structure(s) of the autonomous work vehicle. By way of further example, all obstacle detection sensors of the control system may be mounted to the support structure of the roof assembly.

In certain embodiments, the controller may utilize inputs from multiple obstacle detections sensors to identify obstacle(s) (e.g., the location of the obstacle(s), the distance from the autonomous work vehicle to the obstacle(s), the size and/or shape of the obstacle(s), etc.). For example, the controller may employ one or more algorithms to fuse the data from multiple sensors to identify the obstacle(s). Upon identification of the obstacle(s), the controller may determine whether the obstacle(s) are in the path of the autonomous work vehicle, and if so, update the path to avoid the obstacle(s) and/or stop the autonomous work vehicle.

In the illustrated embodiment, the roof assembly 14 includes the lighting assembly 12. As illustrated, the multicolor light source(s) 84 of the lighting assembly 12 are communicatively coupled to the controller 96. As previously discussed, the controller 96 is configured to select a status indication from a group of status indications, which corresponds to a respective group of operating states of the autonomous work vehicle, based on a current operating state of the autonomous work vehicle. The controller 96 is also configured to output a signal to the multicolor light source(s) 84 indication of the selected status indication. The multicolor light source(s) 84, in turn, are configured to emit light based on the selected status indication. Accordingly, a person positioned outside the autonomous work vehicle may identify the current operating state of the autonomous work vehicle by observing the light emitted from the lighting assembly 12.

In certain embodiments, the group of operating states includes non-operation of the engine of the autonomous work vehicle, operation of the engine of the autonomous work vehicle, occupation of the cab of the autonomous work vehicle, operation of the autonomous work vehicle in a manual mode (e.g., using the manual controls 110), establishment of a connection between the autonomous work vehicle and the base station, movement of the autonomous work vehicle, operation of an actuator of an implement coupled to or towed by the autonomous work vehicle, occurrence of a fault, other suitable operating state(s), or a combination thereof. Furthermore, in certain embodiments, the group of status indications may include emitting light at multiple colors and/or emitting light in multiple flashing patterns. For example, a first status indication of the group of status indications may include emitting light at a first color, and a second status indication of the group of status indications may include emitting light at a second color, different from the first color. By way of further example, the first status indication of the group of status indications may include emitting light in a flashing pattern, and a second status indication of the group of status indications may include emitting light substantially continuously (e.g., continuous from the perspective of an observer, including embodiments in which the multicolor light source is driven by a pulse width modulation (PWM) signal).

In certain embodiments, a first status indication of emitting a substantially continuous red light corresponds to a first operating state of operation of the engine of the autonomous work vehicle. In addition, a second status indication of emitting a flashing red light corresponds to a second operating state of establishment of a connection between the autonomous work vehicle and the base station. Furthermore, a third status indication of emitting a substantially continuous green light corresponds to a third operating state of non-operation of the engine of the autonomous work vehicle. A fourth status indication of emitting a flashing green light corresponds to a fourth operating state of operation of the autonomous work vehicle in the manual mode. Furthermore, a fifth status indication of emitting a substantially continuous blue light corresponds to a fifth operating state of operation of an actuator of an implement coupled to or towed by the autonomous work vehicle. The group of status indications and the corresponding group of operating states may be stored in the memory 104 of the controller 96. In further embodiments, other and/or additional groups of status indications and operating states may be stored (e.g., in the controller memory) and employed to provide a visual indication of the operating state of the autonomous work vehicle to an observer positioned outside the autonomous work vehicle. Furthermore, in certain embodiments, the lighting assembly may be omitted, or the lighting assembly may not be integrated within the roof assembly.

While the autonomous work vehicle controller controls the steering control system, the speed control system, and the lighting assembly in the illustrated embodiment, in alternative embodiments, at least one system/assembly of the autonomous work vehicle may be controlled by one or more other controllers. For example, in certain embodiments, a base station controller may select a status indication based on the current operating state of the autonomous work vehicle and output a signal to the autonomous work vehicle controller indicative of the selected status indication. The work vehicle controller may then control the lighting assembly based on the selected status indication.

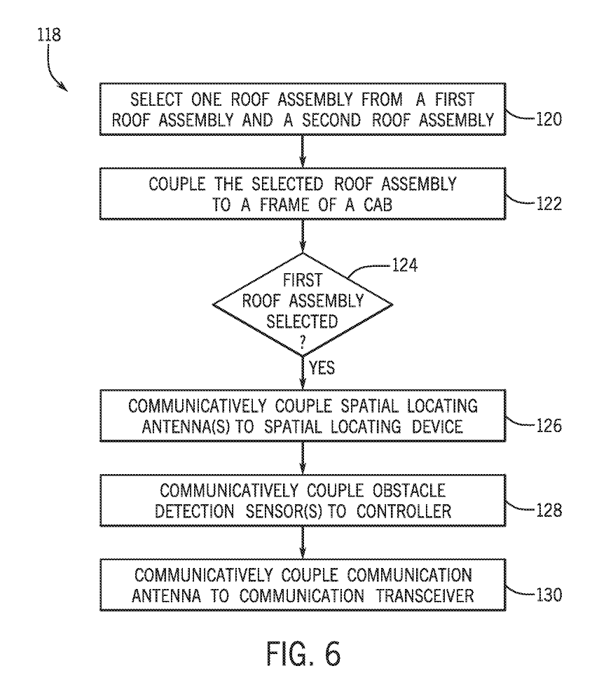

FIG. 6 is a flowchart of an embodiment of a method 118 for manufacturing a work vehicle. First, as represented by block 120, one roof assembly of a first roof assembly and a second roof assembly is selected. The first roof assembly is configured to facilitate autonomous control of the work vehicle. Accordingly, the first roof assembly includes a support structure, at least one spatial locating antenna mounted to the support structure, at least one obstacle detection sensor mounted to the support structure, a communication antenna mounted to the support structure, and a roof panel coupled to the support structure. The roof panel has an outer surface facing an environment external to the work vehicle, the at least one spatial locating antenna and the communication antenna are positioned within an enclosure formed between the support structure and the roof panel, and the roof panel is formed from a single piece of material. For example, the first roof assembly may correspond to the roof assembly described above with reference to FIGS. 1-4. The second roof assembly is configured to be employed on a manually controlled work vehicle. Accordingly, the second roof assembly includes a support structure and a roof panel coupled to (e.g., integrated with) the support structure. The roof panel has an outer surface facing the environment external to the work vehicle, the second roof assembly does not include a spatial locating antenna, and the second roof assembly does not include an obstacle detection sensor.

Once the first or second roof assembly is selected, the selected roof assembly is coupled to a frame of a cab of the work vehicle, as represented by block 122. The selected roof assembly is formed before the roof assembly is coupled to the frame of the cab. By integrating certain components of the autonomous work vehicle control system into the first roof assembly, the process of manufacturing an autonomous work vehicle may be less complex, time-consuming, and expensive than manufacturing an autonomous work vehicle by mounting the components of the control system throughout the work vehicle. Furthermore, while manufacturing the work vehicle, a manually controlled work vehicle may be formed by simply selecting the second roof assembly, and an autonomous work vehicle may be formed by simply selecting the first roof assembly, thereby simplifying the manufacturing process.

If the first roof assembly is selected, as represented by block 126, the at least one spatial locating antenna is communicatively coupled to a spatial locating device, as represented by block 126 (e.g., in embodiments in which the spatial locating device is not mounted to the support structure of the first roof assembly). In addition, if the first roof assembly is selected, the at least one obstacle detection sensor is communicatively coupled to a controller, as represented by block 128 (e.g., in embodiments in which the controller is not mounted to the support structure of the first roof assembly). Furthermore, if the first roof assembly is selected, the communication antenna is communicatively coupled to the communication transceiver, as represented by block 130 (e.g., in embodiments in which the communication transceiver is not mounted to the support structure of the first roof assembly).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A roof assembly for an autonomous work vehicle, comprising:
a roof panel having an outer surface facing an environment external to the autonomous work vehicle;
a lighting assembly comprising at least one light-transmissive panel and at least one multicolor light source, wherein the at least one light-transmissive panel is coupled to the roof panel, the at least one light-transmissive panel has an outer surface facing the environment external to the autonomous work vehicle, the outer surface of the roof panel completely surrounds the outer surface of the at least one light-transmissive panel, and the at least one multicolor light source is configured to emit light through the at least one light-transmissive panel from an inner surface of the at least one light-transmissive panel to the outer surface of the at least one light-transmissive panel;
wherein the at least one multicolor light source is configured to receive a signal from a controller indicative of a selected status indication of a plurality of status indications and to emit the light based on the selected status indication, wherein the plurality of status indications correspond to a respective plurality of operating states of the autonomous work vehicle, and the selected status indication corresponds to a current operating state of the plurality of operating states.

2. The roof assembly of claim 1, wherein the plurality of operational states comprises non-operation of an engine of the autonomous work vehicle, operation of the engine of the autonomous work vehicle, occupation of a cab of the autonomous work vehicle, operation of the autonomous work vehicle in a manual mode, establishment of a connection between the autonomous work vehicle and a base station, movement of the autonomous work vehicle, operation of an actuator of an implement coupled to or towed by the autonomous work vehicle, occurrence of a fault, or any combination hereof.

3. The roof assembly of claim 1, wherein a first status indication of the plurality of status indications comprises emitting the light at a first color, and a second status indication of the plurality of status indications comprises emitting the light at a second color, different from the first color.

4. The roof assembly of claim 1, wherein a first status indication of the plurality of status indications comprises emitting the light in a flashing pattern, and a second status indication of the plurality of status indications comprises emitting the light substantially continuously.

5. The roof assembly of claim 1, wherein the at least one light-transmissive panel comprises a first light-transmissive panel and a second light-transmissive panel, and the first and second light-transmissive panels are positioned on different sides of the roof panel.

6. The roof assembly of claim 5, wherein the at least one multicolor light source comprises a first multicolor light source and a second multicolor light source, the first multicolor light source is configured to emit the light through the first light-transmissive panel, and the second multicolor light source is configured to emit the light through the second light-transmissive panel.

7. The roof assembly of claim 1, wherein the at least one multicolor light source is coupled to the roof panel behind the inner surface of the at least one light-transmissive panel.

8. The roof assembly of claim 1, wherein the at least one light-transmissive panel is formed from a translucent material.

9. A roof assembly for an autonomous work vehicle, comprising:
a support structure;
at least one spatial locating antenna mounted to the support structure;
at least one obstacle detection sensor mounted to the support structure;
a communication antenna mounted to the support structure; and
a roof panel coupled to the support structure, wherein the roof panel has an outer surface facing an environment external to the autonomous work vehicle, the at least one spatial locating antenna and the communication antenna are positioned within an enclosure formed between the support structure and the roof panel, and the roof panel is formed from a single piece of material.

10. The roof assembly of claim 9, wherein the support structure is formed from a single piece of material.

11. The roof assembly of claim 9, wherein the at least one spatial locating antenna comprises a first spatial locating antenna and a second spatial locating antenna, the first spatial locating antenna is positioned on a first lateral side of the roof assembly, and the second spatial locating antenna is positioned on a second lateral side of the roof assembly, opposite the first lateral side.

12. The roof assembly of claim 9, wherein the at least one obstacle detection sensor comprises a LIDAR sensor, a RADAR sensor, a camera, or a combination thereof.

13. The roof assembly of claim 9, comprising a heating, ventilation, and air-conditioning (HVAC) assembly mounted to the support structure.

14. The roof assembly of claim 9, comprising a lighting assembly comprising at least one light-transmissive panel and at least one multicolor light source, wherein the at least one light-transmissive panel is coupled to the roof panel, the at least one light-transmissive panel has an outer surface, the outer surface of the roof panel completely surrounds the outer surface of the at least one light-transmissive panel, and the at least one multicolor light source is configured to emit light through the at least one light-transmissive panel from an inner surface of the at least one light-transmissive panel to the outer surface of the at least one light-transmissive panel.

15. The roof assembly of claim 14, wherein the at least one light-transmissive panel comprises a first light-transmissive panel and a second light-transmissive panel, wherein the first and second light-transmissive panels are positioned on different sides of the roof panel.

16. A method of manufacturing a work vehicle, comprising:
selecting one roof assembly from a first roof assembly and a second roof assembly; and
coupling the one roof assembly to a frame of a cab of the work vehicle;
wherein the one roof assembly is formed before the one roof assembly is coupled to the frame of the cab;
wherein the first roof assembly comprises:
a support structure;
at least one spatial locating antenna mounted to the support structure of the first roof assembly;
at least one obstacle detection sensor mounted to the support structure of the first roof assembly;
a communication antenna mounted to the support structure of the first roof assembly; and
a roof panel coupled to the support structure of the first roof assembly, wherein the roof panel of the first roof assembly has an outer surface facing an environment external to the work vehicle, the at least one spatial locating antenna and the communication antenna are positioned within an enclosure formed between the support structure of the first roof assembly and the roof panel of the first roof assembly, and the roof panel of the first roof assembly is formed from a single piece of material; and
wherein the second roof assembly comprises a support structure and a roof panel coupled to the support structure of the second roof assembly, wherein the roof panel of the second roof assembly has an outer surface facing the environment external to the work vehicle, the second roof assembly does not comprise a spatial locating antenna, and the second roof assembly does not comprise an obstacle detection sensor.

17. The method of claim 16, wherein the first roof assembly comprises a lighting assembly comprising at least one light-transmissive panel and at least one multicolor light source, wherein the at least one light-transmissive panel is coupled to the roof panel of the first roof assembly, the at least one light-transmissive panel has an outer surface, the outer surface of the roof panel of the first roof assembly completely surrounds the outer surface of the at least one light-transmissive panel, and the at least one multicolor light source is configured to emit light through the at least one light-transmissive panel from an inner surface of the at least one light-transmissive panel to the outer surface of the at least one light-transmissive panel.

18. The method of claim 17, wherein the at least one light-transmissive panel comprises a first light-transmissive panel and a second light-transmissive panel, and the first and second light-transmissive panels are positioned on different sides of the roof panel of the first roof assembly.

19. The method of claim 16, comprising:
communicatively coupling the at least one spatial locating antenna of the first roof assembly to a spatial locating device if the one roof assembly is the first roof assembly;
communicatively coupling the at least one obstacle detection sensor of the first roof assembly to a controller if the one roof assembly is the first roof assembly; and
communicatively coupling the communication antenna of the first roof assembly to a communication transceiver if the one roof assembly is the first roof assembly.

20. The method of claim 16, wherein the first roof assembly comprises a heating, ventilation, and air-conditioning (HVAC) assembly mounted to the support structure of the first roof assembly, and the HVAC assembly of the first roof assembly is positioned within the enclosure of the first roof assembly; and
wherein the second roof assembly comprises an HVAC assembly coupled to the support structure of the second roof assembly, and the HVAC assembly of the second roof assembly is positioned within an enclose formed between the support structure of the second roof assembly and the roof panel of the second roof assembly.
